(19) United States
(12) Patent Application Publication
(10) Pub. No.: US 2021/0279004 A1
(43) Pub. Date: Sep. 9, 2021

(54) SSD SYSTEM AND SSD CONTROL SYSTEM

(71) Applicant: Silicon Motion, Inc., Hsinchu County (TW)

(72) Inventors: Chih-Chien Lin, New Taipei City (TW); Hung-Pin Tsai, New Taipei City (TW); Chien-An Chen, Hsinchu County (TW)

(21) Appl. No.: 17/153,894

(22) Filed: Jan. 21, 2021

Related U.S. Application Data
(60) Provisional application No. 62/984,305, filed on Mar. 3, 2020.

(51) Int. Cl. G06F 3/06; G06F 13/16; G06F 13/42

(52) U.S. Cl. CPC G06F 3/0659; G06F 3/0604; G06F 2213/0026; G06F 13/1668; G06F 13/4282; G06F 3/0688

(57) ABSTRACT

An SSD control system comprising a first control system including a first control device, and comprising a second control system including a second control device. The first control system is coupled to a first SSD group comprising a plurality of first SSDs, and the second control system is coupled to a second SSD group comprising a plurality of second SSDs. The first control device comprises: a first processing circuit, configured to control a first portion of the first SSDs; and a second processing circuit, configured to control a second portion of the first SSDs. The second control device comprises: a first signal repeating device, configured to respectively receive first, second control signals from the first, second processing circuit to control a first, second portion of the second SSDs. The second control system does not comprise any circuit which can generate control signals to control the second SSD group.

### CROSS REFERENCE TO RELATED APPLICATIONS

This application claims the benefit of U.S. Provisional Application No. 62/984,305, filed on Mar. 3, 2020, the contents of which are incorporated herein by reference.

### BACKGROUND OF THE INVENTION

### 1. Field of the Invention

The present invention relates to an SSD control system and an SSD system, and particularly relates to an SSD control system and an SSD system which can scale up the number of the SSDs which can be controlled without greatly increasing the cost.

### 2. Description of the Prior Art

In recent years, an SSD (Solid state disk) becomes more and more popular. However, if the user wants to use more SSDs, a control device comprising at least one CPU is needed. However, a cost of such control device is usually high. Therefore, the cost of the whole SSD system greatly increases if the user uses more SSDs.

### SUMMARY OF THE INVENTION

Therefore, one objective of the present invention is to provide an SSD control system which can increase controllable SSDs without greatly increasing the cost.

Therefore, one objective of the present invention is to provide an SSD system which can increase SSDs without greatly increasing the cost.

One embodiment of the present invention provides SSD control system comprising a first control system including a first control device, and comprising a second control system including a second control device. The first control system can be coupled to a first SSD group comprising a plurality of first SSDs, and the second control system can be coupled to a second SSD group comprising a plurality of second SSDs. The first control device comprises: a first processing circuit, configured to control a first portion of the first SSDs; and a second processing circuit, configured to control a second portion of the first SSDs. The second control device comprises: a first signal repeating device, configured to receive first control signals generated by the first processing circuit to control a first portion of the second SSDs, and configured to receive second control signals generated by the second processing circuit to control a second portion of the second SSDs. The second control system does not comprise any circuit which can generate control signals to control the second SSD group.

The first SSD group, the second SSD group and the SSD control system can be regarded as an SSD system.

In view of above-mentioned embodiments, the number of the SSDs which can be controlled can be scaled up without greatly increasing the cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an SSD control system according to one embodiment of the present invention.

FIG. 2 is a block diagram illustrating an SSD control system according to another embodiment of the present invention.

FIG. 3 is a simplified block diagram of the embodiment illustrating in FIG. 2.

FIG. 4 is a schematic diagram illustrating how the first processing circuit and the second processing circuit control the first SSDs and the second SSDs, according to one embodiment of the present invention.

FIG. 5 and FIG. 6 are schematic diagrams illustrating examples of the practical use of the embodiment illustrated in FIG. 2.

FIG. 7 is a schematic diagram illustrating how the SSD control system provided by the present invention scale up the number of the SSDs, according to one embodiment of the present invention.

FIG. 8 and FIG. 9 are schematic diagrams illustrating user interfaces for controlling the SSDs.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Besides, the term “first”, “second”, “third” in following descriptions are only for the purpose of distinguishing different one elements, and do not mean the sequence of the elements. For example, a first device and a second device only mean these devices can have the same structure but are different devices.

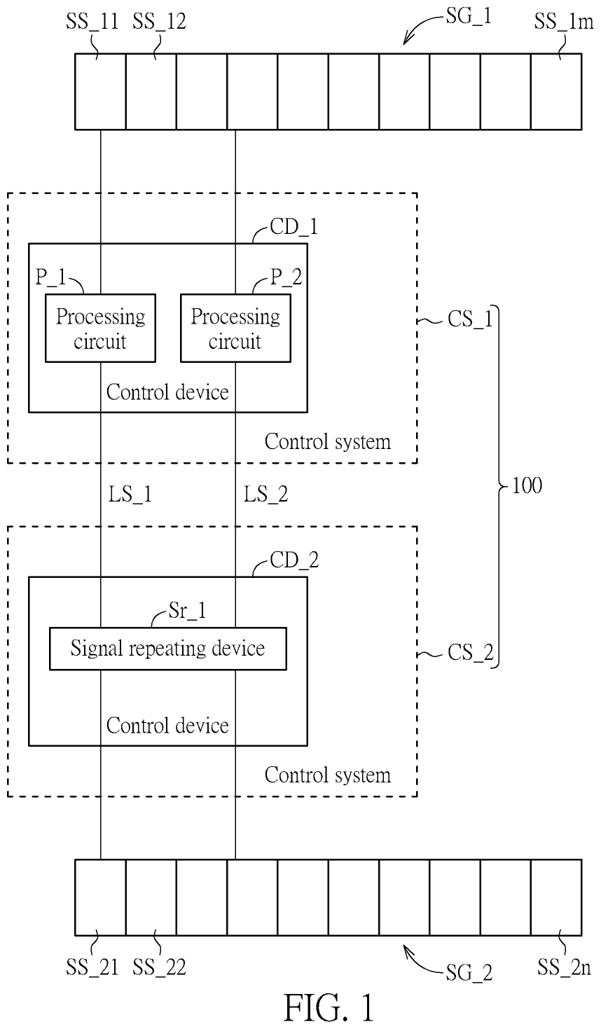

FIG. 1 is a block diagram illustrating an SSD control system according to one embodiment of the present invention. As illustrated in FIG. 1, the SSD control system 100 comprises a first control system CS_1 and a second control system CS_2. The first control system CS_1 is coupled to a first SSD (Solid state disk) group SG_1 and the second control system CS_2 is coupled to a second SSD group SG_2. The first SSD group SG_1 comprises a plurality of first SSDs SS_11, SS_12 . . . SS_1m and the second SSD group SG_2 comprises a plurality of second SSDs SS_21, SS_22 . . . SS_2n. Please note only three of the first SSDs and three of the second SSDs are marked. Also, m and n can be any positive integer. In following embodiments, m=n=24. The first SSD group SG_1, the second SSD group SG_2 and the SSD control system 100 can be regarded as an SSD system.

The first control system CS_1 comprises a first control device CD_1 and a second control device CD_2. The first control device CD_1 comprises a first processing circuit P_1 and a second processing circuit P_2. In one embodiment, the first processing circuit P_1 and the second processing circuit P_2 are CPUs (central processing unit). The first processing circuit P_1 is configured to control a first portion of the first SSDs SS_11-SS1m. Besides, the second processing circuit P_2 is configured to control a second portion of the first SSDs SS_11-SS1m.

The second control device CD_2 comprises a first signal repeating device Sr_1 configured to receive first control signals LS_1 generated by the first processing circuit P_1 to control a first portion of the second SSDs SS_21 . . . SS_2n, and configured to receive second control signals LS_2 generated by the second processing circuit P_2 to control a second portion of the second SSDs SS_21 . . . SS_2n. The first signal repeating device Sr_1 is a device which can extend a range which a signal can transmit. For example, the first signal repeating device Sr_1 can be a re-timer card. Via the first signal repeating device Sr_1, the second SSD group SG_2 can receive correct control signals from the first processing circuit P_1 and the second processing circuit P_2.

In one embodiment, the first control device CD_1 can also comprise a signal repeating device the same as the first signal repeating device Sr_1 to transmit the first control signals LS_1 and the second control signals LS_2. The second control system CS_2 does not comprise any circuit which can generate control signals to control the second SSD group. For example, the second control system CS_2 does not comprise any processing circuit such as the first processing circuit P_1 or the second processing circuit P_2.

Briefly, the SSD control system 100 comprises two control systems (the first control system CS_1 and the second control system CS_2). One of the control systems comprises processing circuits and the other one of the control systems do not comprise processing circuits or any circuit which can generate control signals to control SSDs. The processing circuits can control SSD groups respectively coupled to different control systems. By this way, the number of the SSDs which can be used can be scaled up without a control system comprising processing circuits. Therefore, the number of the SSDs which can be used can be scaled up without greatly increasing the cost of the SSD control system.

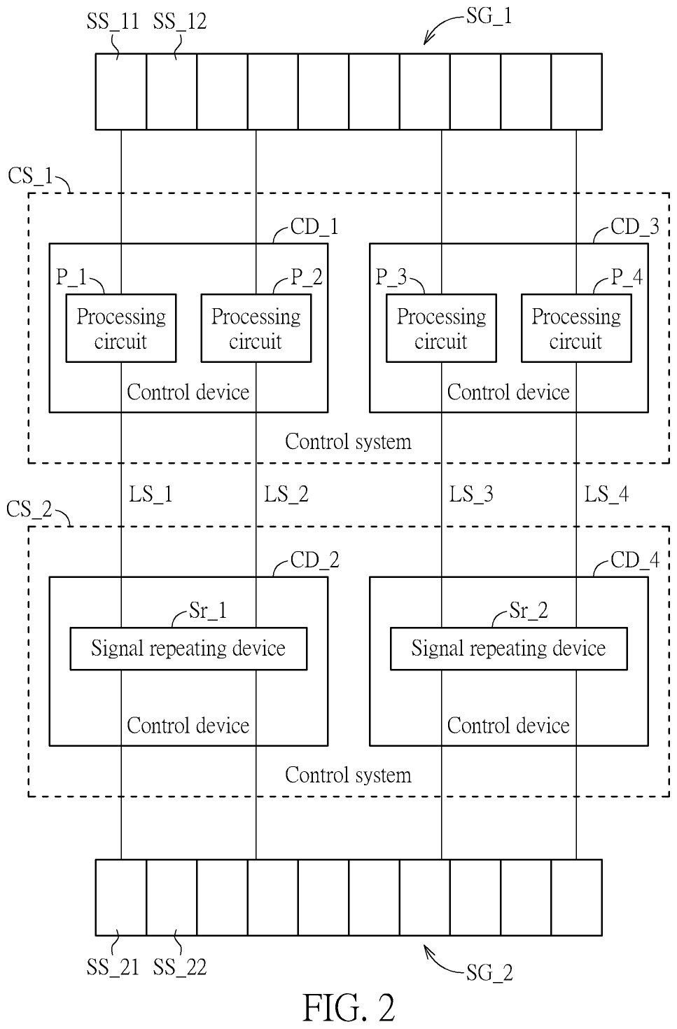

The above-mentioned first control system CS_1 and the second control system CS_2 are not limited to comprise only one control device. FIG. 2 is a block diagram illustrating an SSD control system according to another embodiment of the present invention. As shown in FIG. 2, the first control system CS_1 further comprises a third control device CD_3 and the second control system CS_2 further comprises a fourth control device CD_4. The third control device CD_3 comprises a third processing circuit P_3 and a fourth processing circuit P_4. Also, the fourth control device CD_4 comprises a second signal repeating device Sr_2.

In one embodiment, the third control device CD_3 and the fourth control device CD_4 are served as backup control devices. The first processing circuit P_1 is replaced by the third processing circuit P_3 to control the first portion of the first SSDs SS_11-SS_1m when the first control device CD_1 could not operate normally. Also, the second processing circuit P_2 is replaced by the fourth processing circuit P_4 to control the second portion of the first SSDs SS_11-SS_1m when the first control device CD_1 could not operate normally. For more detail, if the first control device CD_1 could not operate normally, for example, at least one component in the first control device CD_1 is broken, the data in the first control device CD_1 is transferred to the third control device CD_3. After that, the first processing circuit P_1 is replaced by the third processing circuit P_3 and the second processing circuit P_2 is replaced by the fourth processing circuit P_4. In such case, the second signal repeating device Sr_2 is configured to receive third control signals LS_3 generated by the third processing circuit P_3 to control the first portion of the second SSDs SS_21-SS_2n, and configured to receive fourth control signals LS_4 generated by the fourth processing circuit P_4 to control the second portion of the second SSDs SS_21-SS_2n.

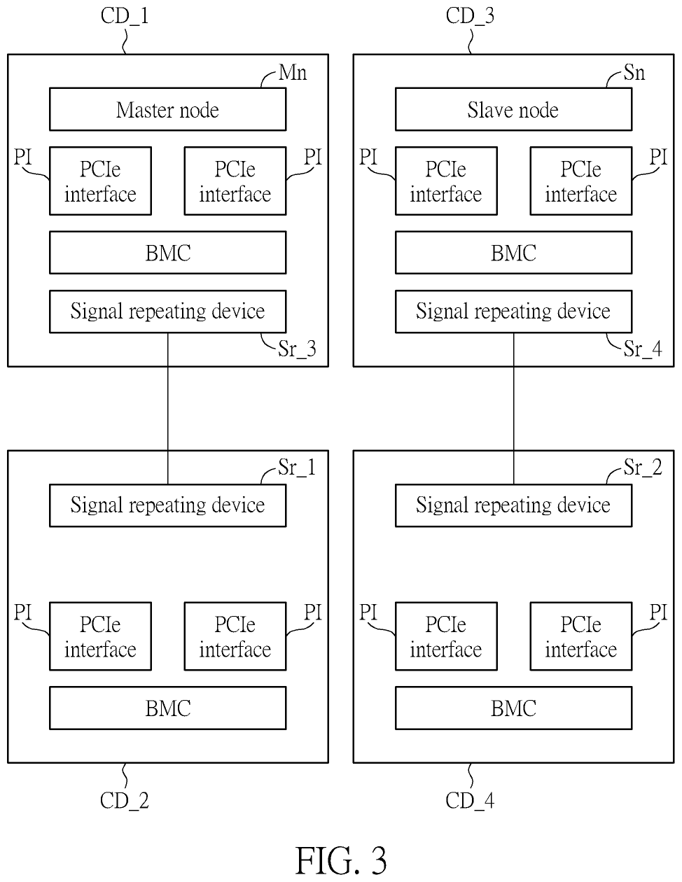

For the convenience of understanding, a simplified block diagram of the first control device CD_1, the second control device CD_2, the third control device CD_3 and the fourth control device CD_4 is illustrated in FIG. 3. As shown in FIG. 3, the first control device CD_1 comprises a master node Mn which means the first processing circuit P_1 and the second processing circuit P_2, and the third control device CD_3 comprises a slave node Sn which means the third processing circuit P_3 and the fourth processing circuit P_4. In such case, the first control device CD_1 can be regarded as a master device and the third control device CD_3 can be regarded as a slave device.

Also, the first signal repeating device Sr_1 and the second signal repeating device Sr_2 are above-mentioned first signal repeating device Sr_1, the second signal repeating device Sr_2 in FIG. 2. In the embodiment of FIG. 3, the first control device CD_1 and the third control device CD_3 respectively comprises the third signal repeating device Sr_3 and the fourth signal repeating device Sr_4. The third signal repeating device Sr_3 and the fourth signal repeating device Sr_4 are configured to transmit control signals from the master node Mn or the slave node Sn to the first signal repeating device Sr_1 and the second signal repeating device Sr_2.

Additionally, in the embodiment of FIG. 3, the first control device CD_1, the second control device CD_2, the third control device CD_3 and the fourth control device CD_4 comprise PCIe interfaces (Peripheral Component Interconnect Express) PI for communication. The control signals generated by the master node Mn and the slave node Sn can be transmitted by the PCIe interfaces. For example, the first signal repeating device Sr_1 can receive the first control signals LS_1 and the second control signals LS_2 via the PCIe interfaces PI. The PCIe interfaces can also be applied to transmit other signals of the SSD control system provided by the present invention.

Furthermore, in one embodiment, the first control device CD_1, the second control device CD_2, the third control device CD_3 and the fourth control device CD_4 respectively comprises a BMC (Board Management Controller) to monitor control device information. The control device information can be, for example, the temperature of the components or the whole control device, the capacity of the SSD, the voltage or the current of the components in the control device. In one embodiment, the first control device CD_1 and the second control device CD_2 respectively comprises a first port configured to transmit and receive the first control signals LS_1 and the second control signals LS_2. Also, the first control device CD_1 and the second control device CD_2 can further respectively comprises a second port configured to transmit or to receive the monitor control device information. Briefly, the first control device CD_1 and the second control device CD_2 has different ports for the control signals and the control device information, and such structure can also be applied to the third control device CD_3 and the fourth control device CD_4.

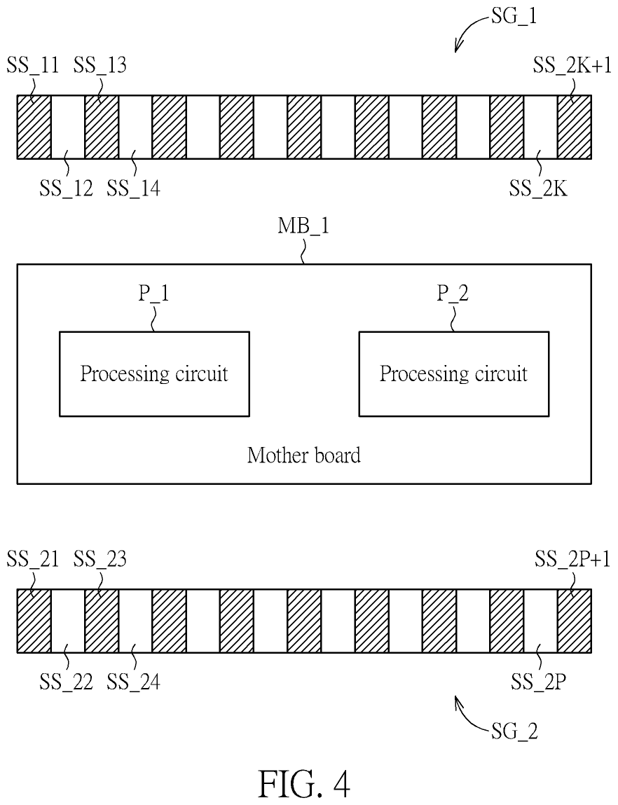

FIG. 4 is a schematic diagram illustrating how the first processing circuit and the second processing circuit control the first SSDs and the second SSDs, according to one embodiment of the present invention. The first portion of the first SDDs are odd-numbered SSD among the first SSDs and the second portion of the first SDDs are even-numbered SSD among the first SSDs. Also, the first portion of the second SDDs are odd-numbered SSD among the second SSDs and the second portion of the second SDDs are even-numbered SSD among the second SSDs. In other words, the first processing circuit P_1 controls the first SSDs SS_11, SS_13 . . . SS_2k+1 and the second SSDs SS_21, SS_23 . . . SS_2p+1. Additionally, the second processing circuit P_2 controls the first SSDs SS_12, SS_14 . . . SS_2k and the second SSDs SS_22, SS_24 . . . SS_2p. k and p are positive integers. The third processing circuit P_3 and the fourth processing circuit P_4 can have the same arrangements illustrated in FIG. 4, thus descriptions thereof are omitted for brevity here.

In one embodiment, the first processing circuit P_1 and the second processing circuit P_2 are provided on a first mother board MB_1, as shown in FIG. 4. Similarly, the third processing circuit P_3 and the fourth processing circuit P_4 are provided on a second mother board which is independent from the first mother board MB_1.

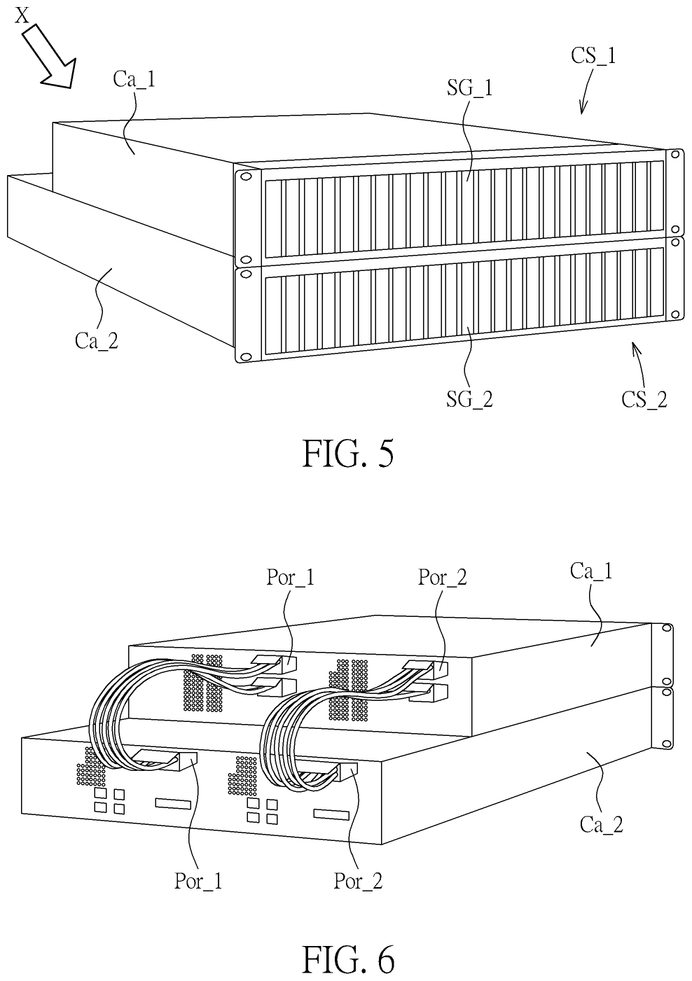

FIG. 5 and FIG. 6 are schematic diagrams illustrating examples of the practical use of the embodiment illustrated in FIG. 2. FIG. 5 is a front view of the embodiment illustrated in FIG. 2. As shown in FIG. 5, the first control system CS_1 and the second control system CS_2 are respectively provided in a first case Ca_1 and a second case CA_2. Also, the first SSDs of the first SSD group SG_1 and the second SSDs of the second SSD group SG_2 are respectively inserted in the first case Ca_1 and the second case Ca_2. In one embodiment, the first SSDs and the second SSDs can be connected to or disconnected from the first control system CS_1 and the second control system CS_2 via hot plugging.

FIG. 6 is a rear view of the embodiment illustrated in FIG. 5. In other words, FIG. 6 is a diagram which is viewed in the x direction in FIG. 5. As illustrated in FIG. 6, the first control device CD_1 and the second control device CD_2 illustrated in FIG. 2 can be connected via the ports Por_1. Additionally, the third control device CD_3 and the second control device CD_4 illustrated in FIG. 2 can be connected via the ports Por_2. As illustrated in FIG. 5 and FIG. 6, the first SSD group SG_1, the first control system CS_1, the second SSD group SG_1, and the second control system CS_2 can be stacked. By this way, the SSD group and the SSD control system provided by the present invention can save more space when connected.

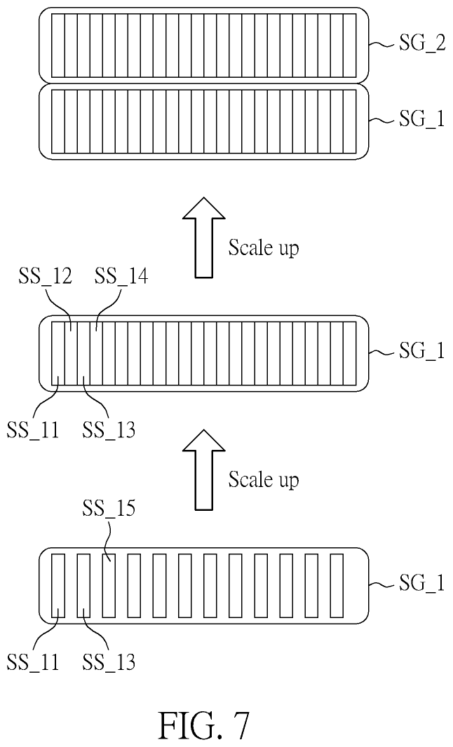

FIG. 7 is a schematic diagram illustrating how the SSD control system provided by the present invention scale up the number of the SSDs. As illustrated in FIG. 7, if only the first processing circuit P_1 in FIG. 1 or FIG. 2 is used, odd-numbered first SSDs SS_11, SS_13 . . . in the first SSD group can be used. If more SSDs are needed, the second processing circuit P_2 in FIG. 1 or FIG. 2 can further be used, thus even-numbered first SSDs SS_12, SS_14 . . . in the first SSD group can further be used. For a conventional SSD control system, if still more SSDs are needed, the user needs to buy an SSD system comprising the SSD group and the SSD control system with processing circuits. However, such SSD system with processing circuits has a high cost. Therefore, based on the above-mentioned embodiments, only an SSD group and a second control system CS_2 having no processing circuit is needed. Such SSD system without processing circuits has a cost lower than which of the SSD system with processing circuits.

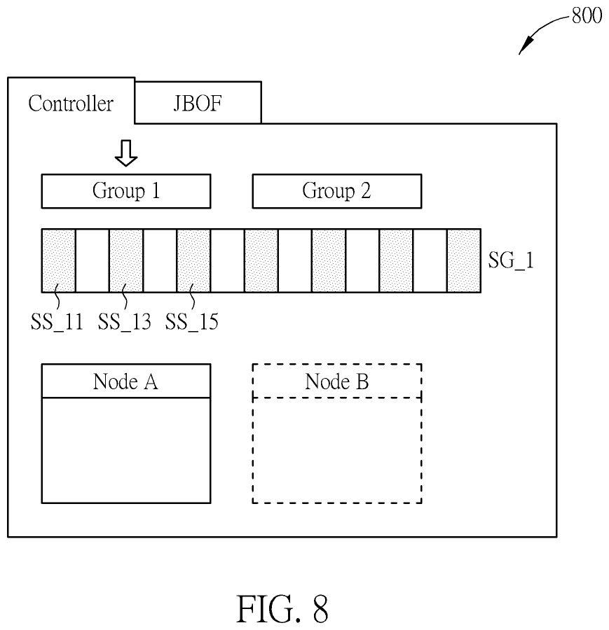

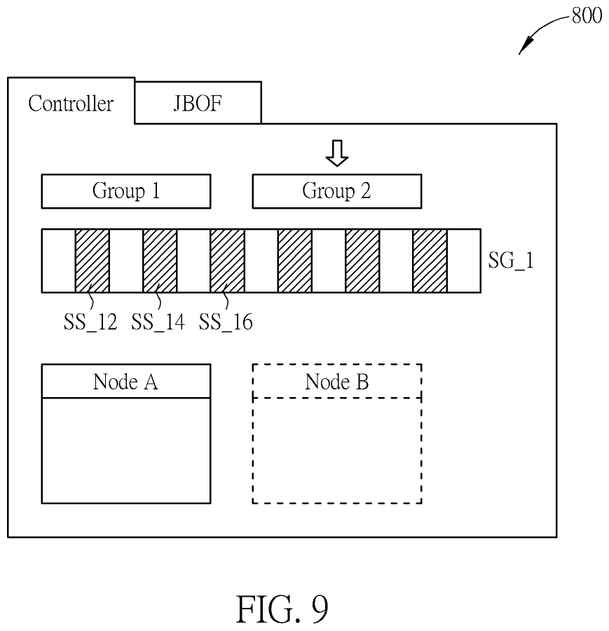

FIG. 8 and FIG. 9 are schematic diagrams illustrating user interfaces for controlling the SSDs. In the embodiment of FIG. 8, the user interface 800 comprises icons of “Controller”, “JBOF”, “Group 1”, “Group 2”, “Node A” and “Node B”. “Controller” means the first SSD control system CS_1 having processing circuits. Also, “JBOF”, which is an abbreviation of “Just a Bunch of Flashes”, means the second SSD control system CS_2 having no processing circuits. Also, the “Group 1” in the page of “Controller” means the first SSDs controlled by the first processing circuit P_1 of the first SSD control system CS_1, and the “Group 2” in the page of “Controller” means the first SSDs controlled by the second processing circuit P_2 of the first SSD control system CS_1. Therefore, if the page of “Controller” and the “Group 1” are selected, the first SSD group SG_1 are displayed and the first SSDs SS_11, SS_13, SS_15 . . . which are controlled by the first processing circuit P_1 are particularly marked (e.g. marked by dots). The “node A” and “node B” means which one of the first control device CD_1 and the third control device CD_3 is used. In the embodiment of FIG. 9, the first control device CD_1 is used, thus the “node A” is displayed by solid lines and the “node B” is displayed by dotted lines.

In the example of FIG. 9, the “Controller” and the “Group 2” are selected, thus the first SSD group SG_1 are displayed and the first SSDs SS_12, SS_14, SS_16 . . . which are controlled by the second processing circuit P_2 are particularly marked (e.g. marked by dots). If the “JBOF” is selected, the user interface 800 can show the same contents shown in FIG. 8 and FIG. 9. The only difference is the shown page is changed from “controller” to “JBOF”

In view of above-mentioned embodiments, the number of the SSDs which can be controlled can be scaled up without greatly increasing the cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An SSD control system, comprising:
a first control system, coupled to a first SSD group (Solid state disk) comprising a plurality of first SSDs, comprising:
a first control device, comprising:
a first processing circuit, configured to control a first portion of the first SSDs; and
a second processing circuit, configured to control a second portion of the first SSDs;
a second control system, coupled to a second SSD group comprising a plurality of second SSDs, comprising:
a second control device, comprising:
a first signal repeating device, configured to receive first control signals generated by the first processing circuit to control a first portion of the second SSDs, and configured to receive second control signals generated by the second processing circuit to control a second portion of the second SSDs;
wherein the second control system does not comprise any circuit which can generate control signals to control the second SSD group.

2. The SSD control system of claim 1,
wherein first control system further comprises a third control device and the second control system further comprises a fourth control device,
wherein the third control device comprises:
a third processing circuit; and
a fourth processing circuit, wherein the first processing circuit is replaced by the third processing circuit to control the first portion of the first SSDs when the first control device could not operate normally, wherein the second processing circuit is replaced by the fourth processing circuit to control the second portion of the first SSDs when the first control device could not operate normally;
wherein the fourth control device comprises:
a second signal repeating device, configured to receive third control signals generated by the third processing circuit to control the first portion of the second SSDs, and configured to receive fourth control signals generated by the fourth processing circuit to control the second portion of the second SSDs.

3. The SSD control system of claim 2,
wherein the first processing circuit, the second processing circuit, the third processing circuit and the fourth processing circuit are CPUs;
wherein the first processing circuit, the second processing circuit are provided on a first mother board, and the third processing circuit, the fourth processing circuit are provided on a second mother board.

4. The SSD control system of claim 2,
wherein the first portion of the first SDDs are odd-numbered SSD among the first SSDs and the second portion of the first SDDs are even-numbered SSD among the first SSDs;
wherein the first portion of the second SDDs are odd-numbered SSD among the second SSDs and the second portion of the second SDDs are even-numbered SSD among the second SSDs.

5. The SSD control system of claim 1, wherein the first control device and the second control device comprise PCIe (Peripheral Component Interconnect Express) interfaces, and the first signal repeating device receives the first control signals and the second control signals via the PCIe interfaces.

6. The SSD control system of claim 1, wherein the first control device and the second control device respectively comprises a BMC (Board Management Controller) to monitor control device information;
wherein the first control device and the second control device respectively comprises a first port configured to transmit and receive the first control signals and the second control signals;
wherein the first control device and the second control device respectively comprises a second port configured to transmit or to receive the monitor control device information.

7. The SSD control system of claim 1,
wherein the first portion of the first SDDs are odd-numbered SSD among the first SSDs and the second portion of the first SDDs are even-numbered SSD among the first SSDs;
wherein the first portion of the second SDDs are odd-numbered SSD among the second SSDs and the second portion of the second SDDs are even-numbered SSD among the second SSDs.

8. The SSD control system of claim 1, comprising:
a first case, wherein the first control system and the first SSDs are provided in the first case; and
a second case, coupled to the first case via at least one port, wherein the second control system and the second SSDs are provided in the second case.

9. The SSD control system of claim 8, comprising:
wherein the first SSDs can be connected to or disconnected from from the first control system by hot plugging;
wherein the second SSDs can be connected to or disconnected from the second control system by hot plugging.

10. The SSD control system of claim 8, wherein the first control system and the second control system are stacked.

11. An SSD system, comprising:
a first SSD group (Solid state disk) comprising a plurality of first SSDs;
a second SSD group comprising a plurality of second SSDs;
a first control system, coupled to the first SSD, comprising:
a first control device, comprising:
a first processing circuit, configured to control a first portion of the first SSDs; and
a second processing circuit, configured to control a second portion of the first SSDs;
a second control system, coupled to the second SSD, comprising:
a second control device, comprising:
a first signal repeating device, configured to receive first control signals generated by the first processing circuit to control a first portion of the second SSDs, and configured to receive second control signals generated by the second processing circuit to control a second portion of the second SSDs;
wherein the second control system does not comprise any circuit which can generate control signals to control the second SSD group.

12. The SSD system of claim 11,
wherein first control system further comprises a third control device and the second control system further comprises a fourth control device,
wherein the third control device comprises:
a third processing circuit; and
a fourth processing circuit, wherein the first processing circuit is replaced by the third processing circuit to control the first portion of the first SSDs when the first control device could not operate normally, wherein the second processing circuit is replaced by the fourth processing circuit to control the second portion of the first SSDs when the first control device could not operate normally;
wherein the fourth control device comprises:
a second signal repeating device, configured to receive third control signals generated by the third processing circuit to control the first portion of the second SSDs, and configured to receive fourth control signals generated by the fourth processing circuit to control the second portion of the second SSDs.

13. The SSD system of claim 12,
wherein the first processing circuit, the second processing circuit, the third processing circuit and the fourth processing circuit are CPUs;
wherein the first processing circuit, the second processing circuit are provided on a first mother board, and the third processing circuit, the fourth processing circuit are provided on a second mother board.

14. The SSD system of claim 12,
wherein the first portion of the first SDDs are odd-numbered SSD among the first SSDs and the second portion of the first SDDs are even-numbered SSD among the first SSDs;
wherein the first portion of the second SDDs are odd-numbered SSD among the second SSDs and the second portion of the second SDDs are even-numbered SSD among the second SSDs.

15. The SSD system of claim 11, wherein the first control device and the second control device comprise PCIe (Peripheral Component Interconnect Express) interfaces, and the first signal repeating device receives the first control signals and the second control signals via the PCIe interfaces.

16. The SSD system of claim 11, wherein the first control device and the second control device respectively comprises a BMC (Board Management Controller) to monitor control device information;
wherein the first control device and the second control device respectively comprises a first port configured to transmit and receive the first control signals and the second control signals;
wherein the first control device and the second control device respectively comprises a second port configured to transmit or to receive the monitor control device information.

17. The SSD system of claim 11,
wherein the first portion of the first SDDs are odd-numbered SSD among the first SSDs and the second portion of the first SDDs are even-numbered SSD among the first SSDs;
wherein the first portion of the second SDDs are odd-numbered SSD among the second SSDs and the second portion of the second SDDs are even-numbered SSD among the second SSDs.

18. The SSD system of claim 11, comprising:
a first case, wherein the first control system and the first SSDs are provided in the first case; and
a second case, coupled to the first case via at least one port, wherein the second control system and the second SSDs are provided in the second case.

19. The SSD system of claim 18, comprising:
wherein the first SSDs can be connected to or disconnected from the first control system by hot plugging;
wherein the second SSDs can be connected to or disconnected from the second control system by hot plugging.

20. The SSD system of claim 18, wherein the first control system and the second control system are stacked.
